(19) United States
(12) Patent Application Publication
(10) Pub. No.: US 2017/0272484 A1
(43) Pub. Date: Sep. 21, 2017

(54) METHOD AND ELECTRONIC DEVICE FOR AUTOMATICALLY ADJUSTING MULTIMEDIA DATA FLOW BASED ON ONLINE PLAYING

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Zhibin LIU, Beijing (CN)

(21) Appl. No.: 15/247,057

(22) Filed: Aug. 25, 2016

Related U.S. Application Data
(63) Continuation of application No. PCT/CN2016/088864, filed on Jul. 6, 2016.

(30) Foreign Application Priority Data
Mar. 21, 2016 (CN) 201610162433.6

(51) Int. Cl. H04L 29/06

(52) U.S. Cl. CPC H04L 65/601; H04L 67/42

(57) ABSTRACT

A method and an electronic device for automatically adjusting multimedia data flow based on online playing are disclosed. The method includes: receiving an online playing data packet acquisition request, which comprises a selected playing standard; determining whether an occupation ratio of a current broadband is higher than a preset first broadband threshold; if yes, determining whether the selected playing standard is higher than a preset playing standard, and if the selected playing standard is higher than the preset playing standard, adjusting a playing standard of a multimedia data packet as the preset playing standard and sending the multimedia data packet according to the adjusted playing standard; and if the selected playing standard is not higher than the preset playing standard, sending the multimedia data packet according to the selected playing standard; and if not, sending the multimedia data packet according to the selected playing standard.

### CROSS-REFERENCE TO RELATED APPLICATIONS

This application is a continuation of International Application No. PCT/CN2016/088864, with an international filing date of Jul. 6, 2016, which is based upon and claims priority to Chinese Patent Application No. 201610162433.6, filed on Mar. 21, 2016, the entire contents of all of which are incorporated herein by reference.

### TECHNICAL FIELD

The present disclosure relates to the field of multimedia online playing technologies, and in particular, to a method and an electronic device for automatically adjusting multimedia data flow based on online playing.

### BACKGROUND

Currently, with constant development and popularization of network technologies, more users watch multimedia videos online by using a network. When a user watches multimedia videos online, a server needs to transmit a multimedia data packet in real time to a terminal. In existing devices, when multimedia playing is performed by using a terminal, a user downloads multimedia data in real time from a server and plays the multimedia data by using a player on the terminal. Commonly, multimedia playing has multiple quality standard; the higher the multimedia quality standard are, the larger multimedia flow is. When a user selects to perform high-standard playing, a terminal constantly downloads high-standard multimedia data from a server for playing.

### SUMMARY

An embodiment of the present disclosure provides a method for automatically adjusting multimedia data flow based on online playing. The method includes:

at an electronic device:

receiving an online playing data packet acquisition request, which comprises a selected playing standard;

determining whether an occupation ratio of a current broadband is higher than a preset first broadband threshold;

if yes, determining whether the selected playing standard is higher than a preset playing standard, and if the selected playing standard is higher than the preset playing standard, adjusting a playing standard of a multimedia data packet as the preset playing standard and sending the multimedia data packet according to the adjusted playing standard; and if the selected playing standard is not higher than the preset playing standard, sending the multimedia data packet according to the selected playing standard; and

if not, sending the multimedia data packet according to the selected playing standard.

Another embodiment of the present disclosure provides an electronic device. The electronic device includes:

at least one processor; and

a memory communicably connected with the at least one processor for storing instructions executable by the at least one processor, wherein execution of the instructions by the at least one processor causes the at least one processor to:

receive an online playing data packet acquisition request, which comprises a selected playing standard;

determine whether an occupation ratio of a current broadband is higher than a preset first broadband threshold;

if yes, determine whether the selected playing standard is higher than a preset playing standard, and if the selected playing standard is higher than the preset playing standard, adjust a playing standard of a multimedia data packet as the preset playing standard and send the multimedia data packet according to the adjusted playing standard; and if the selected playing standard is not higher than the preset playing standard, send the multimedia data packet according to the selected playing standard; and

if not, send the multimedia data packet according to the selected playing standard.

Still another embodiment of the present disclosure provides a non-transitory computer-readable storage medium. The non-transitory computer-readable storage medium stores executable instructions, wherein when the executable instructions are executed by an electronic device, causes the electronic device to:

receive an online playing data packet acquisition request, which comprises a selected playing standard;

determine whether an occupation ratio of a current broadband is higher than a preset first broadband threshold;

if yes, determine whether the selected playing standard is higher than a preset playing standard, and if the selected playing standard is higher than the preset playing standard, adjust a playing standard of a multimedia data packet as the preset playing standard and send the multimedia data packet according to the adjusted playing standard; and if the selected playing standard is not higher than the preset playing standard, send the multimedia data packet according to the selected playing standard; and

if not, send the multimedia data packet according to the selected playing standard.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of an embodiment of a method for automatically adjusting multimedia data flow based on online playing according to the present disclosure;

FIG. 2 is a flowchart of another embodiment of a method for automatically adjusting multimedia data flow based on online playing according to the present disclosure;

FIG. 3 is a flowchart of an embodiment of an apparatus for automatically adjusting multimedia data flow based on online playing according to the present disclosure; and

FIG. 4 is a flowchart of another embodiment of an apparatus for automatically adjusting multimedia data flow based on online playing according to the present disclosure.

FIG. 5 is a flowchart of another embodiment of an electronic device for automatically adjusting multimedia data flow based on online playing according to the present disclosure.

### DETAILED DESCRIPTION

To make an objective, technical solutions, and advantages of the present disclosure clearer, the present disclosure is further described in detail below with reference to specific embodiments and the figures.

It should be noted that all expressions using “first” and “second” in an embodiment of the present disclosure are to distinguishing two non-identical entities or non-identical parameters having same titles. It can be known that “first” and “second” are only for convenience of expression and should not be understood as limitation to the embodiment of the present disclosure, which is not described in detail in subsequent embodiments.

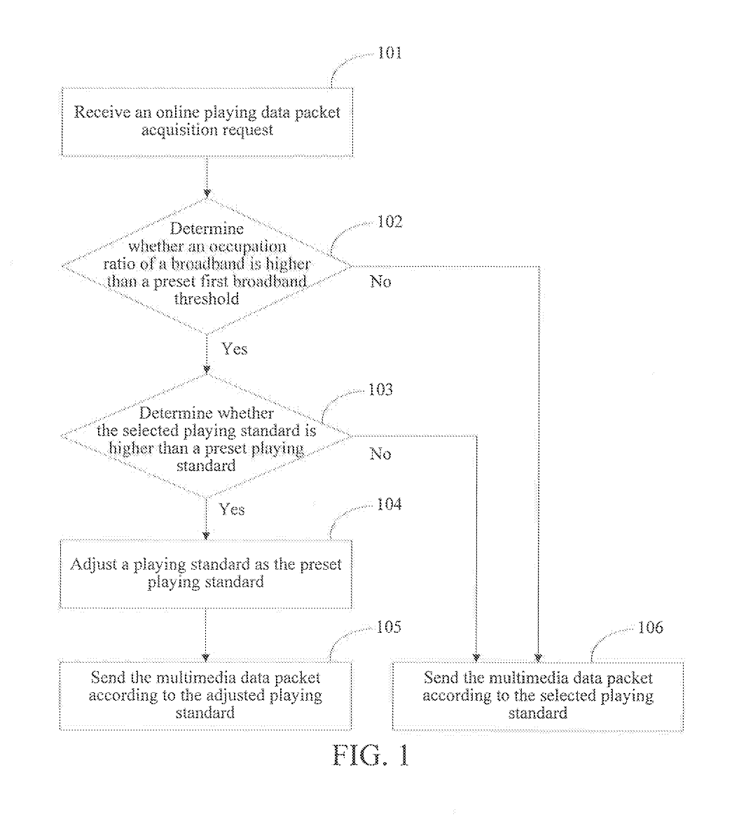

Referring to FIG. 1, FIG. 1 is a flowchart of an embodiment of a method for automatically adjusting multimedia data flow based on online playing according to the present disclosure. The shown method for automatically adjusting multimedia data flow based on online playing includes:

In step 101: Receive an online playing data packet acquisition request, which includes a selected playing standard.

The shown online playing data packet acquisition request refers to a command or an instruction sent to a server and configured to request downloading a multimedia file when an terminal user needs online playing of videos. Because online playing of multimedia requires constant requests of a terminal to the server, performing online playing by constantly downloading a segment or a frame of the multimedia file, the online playing data packet here refers to a segment or a frame of a multimedia file to be acquired. The selected playing standard usually refers to selected playing standard when a user selects online playing, and if the user does not select a playing standard, a preset default playing standard of a system is used as the selected playing standard. Certainly, other manners may also be configured to select the playing standard.

In step 102: Determine whether an occupation ratio of a current broadband is higher than a preset first broadband threshold; if yes, go to step 103; and if not, go to step 106.

The occupation ratio of the broadband refers to a running performance index of the server and is specifically a ratio of a broadband occupied by data transmission to a total broadband of the server at a current moment. The first broadband threshold is a numerical value, such as 80% and 90%, of the occupation ratio of the broadband that is preset according to running performances of the server.

In step 103: According to step 102, when the occupation ratio of the current broadband is higher than the preset first broadband threshold, it indicates that a load of the server reaches a particular range and may cause stalling of output transmission; in this case, determine whether the selected playing standard is higher than a preset playing standard; if the selected playing standard is higher than the preset playing standard, go to step 104; and if the selected playing standard is not higher than the preset playing standard, go to step 106.

The preset playing standard refers to a playing standard that is correspondingly set according to a situation of the first broadband threshold; if the occupation ratio of the broadband exceeds the first broadband threshold, the playing standard needs to be adjusted as a relatively low playing standard, that is, the preset playing standard, to ensure the server to run smoothly.

In step 104: According to step 103, if the selected playing standard is higher than the preset playing standard, it indicates that a playing standard, desired by the terminal, of online playing is excessively high; adjust a playing standard of the multimedia data packet as the preset playing standard, so that no stalling occurs in output transmission of the server.

In step 105: Send the multimedia data packet according to the adjusted playing standard after the playing standard is adjusted. Finally, fluency and stability of online playing of the user are made to be implemented when a carrying capacity range of the server is satisfied.

In step 106: According to step 102 and step 103, if the occupation ratio of the broadband does not exceed the first broadband threshold or the selected playing standard is not higher than the preset playing standard, it indicates that a capacity of the server is surplus; or even if the server overloads but the selected playing standard is still within an acceptable range, in this case, the server sends the multimedia data packet still according to the selected playing standard.

It can be known from the foregoing embodiment that the method for automatically adjusting multimedia data flow based on online playing of the embodiment of the present disclosure includes setting an occupation ratio threshold of a broadband and a corresponding set playing standard at a server end, so that when running of a server overloads, that is, an occupation ratio of the threshold is greater than a first broadband threshold, and a terminal selects a relatively high-standard playing standard, the relatively high playing standard needs to be adjusted as a preset playing standard, so that the server can stably and effectively runs, and stalling does not occur. Further, better experience of online playing of videos is brought to a user.

As an optional embodiment of the present disclosure, before step 102 of the determining whether an occupation ratio of a current broadband is higher than a preset first broadband threshold, the method includes:

determining whether current time is within an interval of a preset peak period, and if the current time is within the preset peak period, directly adjusting the playing standard of the multimedia data packet as the preset playing standard and sending the multimedia data packet according to the adjusted playing standard; and

if the current time is not within the preset peak period, executing step 102 of the determining whether an occupation ratio of a current broadband is higher than a preset first broadband threshold.

It is regular in time that the user plays videos online, or within some periods, a quantity of videos that the user plays online clearly rises or drops; for example, within a time interval of 6 to 10 o'clock at night, usually relatively many users use computers, mobile phones, or other terminals, and on the contrary, usually very few people watch videos online during 0 to 6 o'clock in the morning. Therefore, specific to the situation, a time range during which a quantity of users that watch videos online is relatively large, and a peak period area can be obtained according to regularity for users to play videos online. In this way, situations in which the server overloads can be quickly screened by pre-determining whether to be in a peak period, and the occupation ratio of the broadband and the playing standard do not need to be determined. Finally, a speed and an efficiency of adjustment of multimedia data flow of online playing can be greatly improved.

Certainly, when the current time is within the preset peak period, step 103 of the determining whether the selected playing standard is higher than a preset playing standard may be first entered, and the standard needs to be lowered to the preset playing standard only when it is determined that an terminal user selects a high standard. In this way, adjustment of the playing standard is made to be more accurate and stable. A situation in which it brings burden to the server that a lower-level playing standard selected by the terminal user is adjusted as a relatively high-level predetermined playing standard does not occur,

Further, a different playing standard is correspondingly set for the interval of the peak period, that is, when the current time within the interval of the peak period, the playing criteria is adjusted as the preset second playing standard. In this way, a different playing standard different from the previous one may be set according to different situations of the interval of the peak period, to implement more accurate adjustment of multimedia data flow, making the server run more stably and safely.

In optional embodiment of the present disclosure, before step 103 of the determining whether the selected playing standard is higher than a preset playing standard, the method includes: acquiring and determining whether the terminal user is an advanced user; if the terminal user is an advanced user, sending the multimedia data packet according to the selected playing standard; and if the terminal user is not an advanced user, executing step 103 of the determining whether the selected playing standard is higher than a preset playing standard.

Here, the advanced user is an expression manner configured to distinguishing user levels and should not be limited to description whether a user is advanced. For example, it may also be described as whether the user is logged in; if a logged in user is an advanced user, a non-logged in user is not an advanced user. Alternatively, a standard level may be preset according to different levels of use login; if a level of the user is higher than the standard level, it indicates that the user is an advanced user, and if the level of the user is not higher than the standard level, the user is not an advanced user. In this way, the user level is determined so that even if the server overloads, the advanced user is not adjusted to select the playing standard, so as to ensure rights of the advanced user and make management of online playing more reasonable and orderly.

Further, before step 104 of the adjusting a playing standard of the multimedia data packet as the preset playing standard, the method includes:

determining whether the occupation ratio of the current broadband is higher than a preset second broadband threshold;

if yes, executing step 104 of the adjusting a playing standard of a multimedia data packet as the preset playing standard, and if not, determining whether an online playing data packet is an opening credit or closing credit part of a multimedia file; and

if the data packet is an opening credit or closing credit part, adjusting the playing standard of the multimedia data packet as the preset playing standard; and if the data packet is not an opening credit or closing credit part, sending the multimedia data packet according to the selected playing standard.

The second broadband threshold is a controllable safety online threshold set according to performances of the server; when the occupation ratio of the broadband of the server is higher than the preset first broadband threshold and is not higher than the second broadband threshold, it indicates that although the server overloads, overloading is not very serious, and the occupation ratio of the broadband may be lowered by adjusting some of multimedia playing criteria that are relatively secondary. The opening credit or closing credit part is configured to distinguish relative importance degrees of multimedia files and is not limited to the opening credit or closing credit of a video file. For example, it may also represent an advertisement part of a video. When the occupation ratio of the broadband of the server is higher than the preset first broadband threshold and is not higher than the second broadband threshold, it indicates that data flow of the server is still in a controllable range. In the case, whether the multimedia data packet is the opening credit or closing credit part of the multimedia file is determined, and more accurate adjustment of data flow may be implemented by adjusting a playing standard of the multimedia opening credit or closing credit part. In this way, based on that running performances of the server are satisfied, online playing of the terminal user is not influenced as much as possible, so that the terminal user has better experience of online playing of videos.

In another optional embodiment of the present disclosure, if the playing standard has n different levels from low to high, (n−1) first broadband thresholds from low to high are correspondingly set, and if the occupation ratio of the current broadband is greater than an i^{th} first broadband threshold and is not greater than an (i+1)^{th} first broadband threshold, the corresponding preset playing standardise the (n−i)^{th} level, where i=1, 2, 3, . . . , n−1, and n is a natural number.

In this way, multiple first broadband thresholds are set so that adjustment of the playing standard is more accurate and fine, that is, the playing standard of online playing may be adjusted according to different interval ranges in which occupation ratios of the broadband are. For example, if playing levels have four levels, fluent, standard-definition, high-definition, and ultra-high-definition, the first broadband threshold may be set to 70%, 80%, and 90%. Correspondingly, if the occupation ratio of the broadband is within 70% to 80%, the preset playing standard is high-definition; if the occupation ratio of the broadband is within 80% to 90%, the preset playing standard is standard-definition; the occupation ratio of the broadband is larger than 90%, the preset playing standard is fluent. As a result, the playing standard may be correspondingly adjusted according to the magnitude of the occupation ratio of the broadband; the larger the occupation ratio is, the lower the corresponding preset playing standard is.

Further, the interval of the peak period may be set to be of multiple groups. If the playing standard has n different levels from low to high, (n−1) groups of peak period intervals having different levels may be set; each peak period interval having a different level corresponds to a preset playing standard, that is, a peak period interval having a maximum occupation ratio of the broadband corresponds to a playing standard having a second level from the bottom; the remaining ones correspond in sequence. In this way, accurate adjustment of the playing standard of online playing multimedia in the peak period interval may be implemented so as to improve an adjustment efficiency and stability of multimedia data flow.

In some optional embodiments, before step 102, whether the selected playing standard is a lowest-level playing standard is first determined; if yes, the terminal directly performs adjustment and performs data transmission and playing according to the selected playing standard; and if not, determining in step 102 is executed. In this way, an online playing request having a minimum standard can be quickly screened. Because these playing criteria can be impossibly lowered, playing requests of terminal users of this kind are screened, which can greatly improve the adjustment efficiency and accuracy of multimedia data flow.

In some optional embodiments, in step 102, the method includes: determining whether an occupation ratio of a current broadband is higher than a preset first broadband threshold; if a determining result is negative, determining whether determining results of continuous k times are negative, where the k is a preset times threshold; and if yes, not executing the step of determining whether an occupation ratio of a current broadband is higher than a preset first broadband threshold on m online playing data packet acquisition requests that are received hereafter and directly sending the multimedia data packet according to the selected playing standard, where m is a preset quantity threshold. For example, the preset times threshold is five, and the preset quantity threshold is ten; when determining results of continuous five times is negative, it indicates that the occupation ratio of the broadband is in a relatively low range for continuous five times; then online playing requests of ten times received thereafter do not execute a determining process but are played directly according to the selected playing standard. In this way, the determining process is not executed each time, greatly improving a determining efficiency, reducing the burden for the server, and making the adjustment efficiency of multimedia data flow higher and quicker.

Further, the step of determining whether determining results of continuous k times are negative includes:

if the determining results of continuous k times are negative, further subtracting 1 from the times threshold k until k is equal to 1; and

if a determining result that the occupation ratio of the current broadband is higher than the preset first broadband threshold occurs once, recovering the times threshold to the original value k;

and/or

the step of determining whether determining results of continuous k times are negative includes:

if the determining results of continuous k times are negative, further adding 1 to the quantity threshold m until a value of m reaches a predetermined upper quantity threshold; and

if a determining result that the occupation ratio of the current broadband is higher than the preset first broadband threshold occurs once, recovering the quantity threshold m to the original value. In this way, a determining speed may be further improved by constantly optimizing the times threshold and the quantity threshold. For example, if the preset times threshold is five and the preset quantity threshold is ten, when that determining results of continuous five times are negative occurs once, as long as determining results of continuous four times are negative next time, determining may not be performed for continuous ten times. Similarly, when the determining results of continuous five times are negative, when that continuous determining is negative occurs again next time, a determining step is not executed for continuous 11 times. In this way, the times threshold and the quantity threshold may be adjusted in time according to an occupation status of the current broadband, further improving an adjustment speed of multimedia data flow.

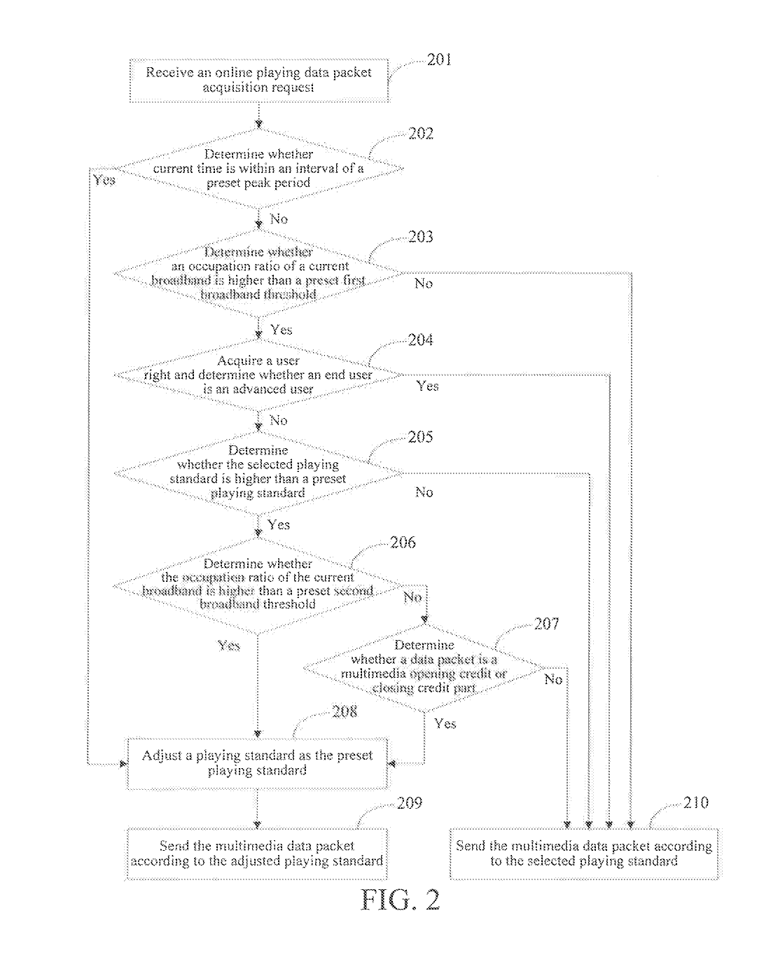

Referring to FIG. 2, FIG. 2 is a flowchart of another embodiment of a method for automatically adjusting multimedia data flow based on online playing according to the present disclosure. The shown method for automatically adjusting multimedia data flow based on online playing includes:

In step 201: Receive an online playing data packet acquisition request, which includes a selected playing standard.

In step 202: Determine whether current time is within an interval of a preset peak period; if yes, go to step 208; and if not, go to step 203.

In step 203: According to step 202, if the current time is not within the preset peak period, determine whether an occupation ratio of a current broadband is higher than a preset first broadband threshold; if yes, go to step 204; and if not, go to step 210.

In step 204: According to step 203, if the occupation ratio of the current broadband is higher than the preset first broadband threshold, it indicates that the broadband occupies too much; in this case, determine whether a user is an advanced user; if yes, go to step 210; and if not, go to step 205.

In step 205: According to step 204, if the user is not an advanced user, determine whether the selected playing standard is higher than a preset playing standard; if the selected playing standard is higher than the preset playing standard, go to step 206; and if the selected playing standard is not higher than the preset playing standard, go to step 210.

In step 206: According to step 205, if the selected playing standard is higher than the preset playing standard, determine whether the occupation ratio of the current broadband is higher than a preset second broadband threshold; if yes, go to step 208; and if not, go to step 207.

In step 207: According to step 206, if the occupation ratio of the current broadband is not higher than the preset second broadband threshold, it indicates that the occupation ratio of the broadband is still in a controllable range; determine whether a data packet is a multimedia opening credit or closing credit part; if yes, go to step 208; and if not, go to step 210.

In step 208: According to step 206 or step 207, if the occupation ratio of the broadband is higher than the preset second broadband threshold, it indicates that the occupation ratio of the broadband reaches a relatively high dangerous interval; or although the occupation ratio of the broadband is still in a controllable range, the data packet is a multimedia opening credit or closing credit part. In this case, a playing standard needs to be adjusted as the preset playing standard.

In step 209: A server sends the multimedia data packet according to the adjusted playing standard.

In step 210: According to step 203, step 204, step 205, or step 207, maintain the playing standard selected by a user; and the server sends the multimedia data packet according to the selected playing standard.

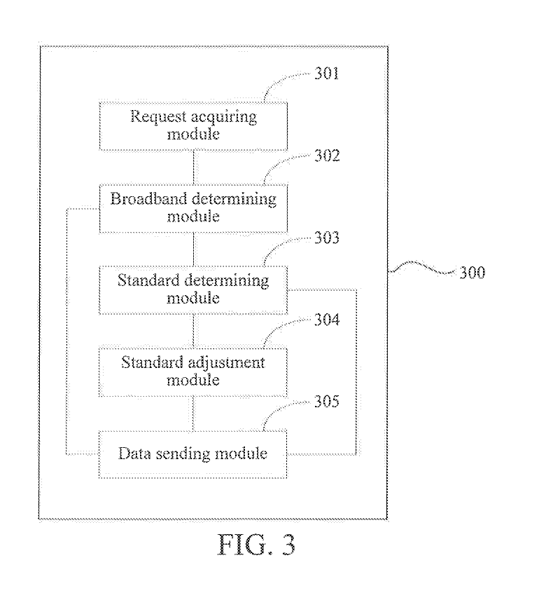

Referring to FIG. 3, FIG. 3 is a flowchart of an embodiment of an apparatus for automatically adjusting multimedia data flow based on online playing 300 according to the present disclosure. The apparatus for automatically adjusting multimedia data flow based on online playing 300 includes:

a request acquiring module 301, configured to receive an online playing data packet acquisition request and instruct a broadband determining module 302 to perform determining, where the online playing data packet acquisition request includes a selected playing standard;

the broadband determining module 302, configured to determine whether an occupation ratio of a current broadband is higher than a preset first broadband threshold, if yes, instruct a standard determining module 303 to perform determining, and if not, instruct a data sending module 305 to send a multimedia data packet according to the selected playing standard;

the standard determining module 303, configured to determine whether the selected playing standard is higher than a preset playing standard according to an instruction of the broadband determining module 302, if yes, instruct a standard adjustment module 304 to adjust the playing standard of the multimedia data packet as the preset playing standard, and if not, instruct the data sending module 305 to send the multimedia data packet according to the selected playing standard;

the standard adjustment module 304, configured to adjust the playing standard of the multimedia data packet as the preset playing standard according to an instruction of the standard determining module 303 and instruct the data sending module 305 to send the multimedia data packet according to the adjusted playing standard; and

the data sending module 305, configured to send the multimedia data packet according to the selected playing standard according to the instructions of the broadband determining module 302 and the standard determining module 303 and send the multimedia data packet according to the adjusted playing standard according to an instruction of the standard adjustment module 304.

It can be known from the foregoing embodiment that a user screens a playing request having a relatively high broadband occupation ratio and a relatively high selected playing standard by using the broadband determining module 302 and the standard determining module 303, and then adjusts a relatively-high-standard playing standard as a preset playing standard by using the standard adjustment module 304, to complete automatic adjustment of online playing multimedia data flow, so that a server can run stably and reliably, and finally, the user has better experience of online playing.

In optional embodiment of the present disclosure, the apparatus for automatically adjusting multimedia data flow based on online playing 300 includes:

a peak determining module 306, configured to: determine whether current time is within an interval of a preset peak period, and if the current time is within the preset peak period, instruct the standard adjustment module 304 to adjust the playing standard of the multimedia data packet as the preset playing standard; and

if the current time is not within the preset peak period, instruct the broadband determining module 302 to perform determining, where

the standard adjustment module 304 is configured to adjust the playing standard of the multimedia data packet as the preset playing standard according to an instruction of the peak determining module 306.

In this way, whether the current time is within the interval of the peak period is predetermined by using the peak determining module 306, improving the adjustment speed and efficiency of multimedia data flow.

In another optional embodiment of the present disclosure, the apparatus for automatically adjusting multimedia data flow based on online playing 300 includes:

a right determining module 307, configured to: acquire and determine whether an terminal user is an advanced user;

if the terminal user is an advanced user, instruct the data sending module 305 to send the multimedia data packet according to the selected playing standard; and

if the terminal user is not an advanced user, instruct the standard determining module 303 to perform determining.

In this way, an advanced user can be screened by using the right determining module 307, so as to ensure that if the playing standard needs to be adjusted, right of an advanced right is not influenced, and management of playing multimedia online can be specified.

Further, the apparatus for automatically adjusting multimedia data flow based on online playing 300 includes:

a controllable determining module 308, configured to: determine whether the occupation ratio of the current broadband is higher than a preset second broadband threshold;

if yes, instruct the standard adjustment module 304 to adjust the playing standard of the multimedia data packet as the preset playing standard; and if not, instruct a data packet determining module 309 to perform determining; and

the data packet determining module 309, configured to: determine whether the online playing data packet is an opening credit or closing credit part of a multimedia file;

if yes, instruct the standard adjustment module 304 to adjust the playing standard of the multimedia data packet as the preset playing standard; and if not, instruct the data sending module 305 to send the multimedia data packet according to the selected playing standard, where

the standard adjustment module 304 is configured to adjust the playing standard of the multimedia data packet as the preset playing standard according to an instruction of the data packet determining module 309.

In this way, the playing standard can be adjusted more in detail by using the controllable determining module 308 and the data packet determining module 309. Specifically, when the occupation ratio of the broadband is higher than the preset first broadband threshold but is not higher than the second broadband threshold, it indicates that the occupation ratio of the broadband is not very high, and stable running of the server may still be ensured by adjusting some of multimedia. Here, the data packet determining module 309 can screen a data packet belonging to an opening credit or closing credit part of multimedia; then playing criteria of data packets of only this kind are adjusted as preset playing criteria, and the selected playing standard is maintained for important parts of multimedia. In this way, an efficiency and quality for the server to transmit a multimedia file may be improved based on ensuring user experience.

In optional embodiment of the present disclosure, if the playing standard has n different levels from low to high, (n−1) first broadband thresholds from low to high are correspondingly set, and if the occupation ratio of the current broadband is greater than an i^{th} first broadband threshold and is not greater than an (i+1)^{th} first broadband threshold, the corresponding preset playing standardise the (n−i)^{th} level, where i=1, 2, 3, . . . , n−1, and n is a natural number. In this way, adjustment of the playing standard is made to be more accurate and detailed by setting multiple criteria, further improving stability of the apparatus for automatically adjusting multimedia data flow based on online playing 300.

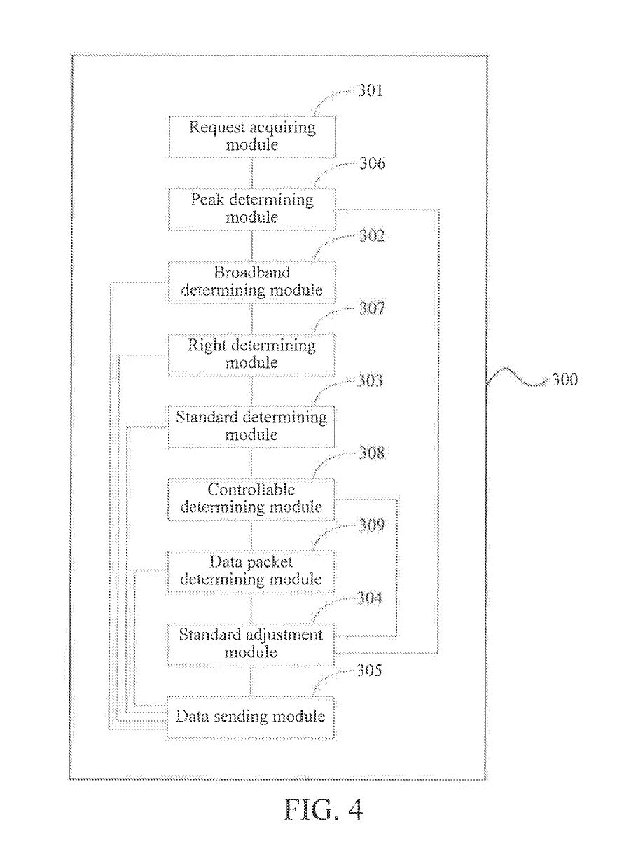

Referring to FIG. 4, FIG. 4 is a flowchart of another embodiment of an apparatus for automatically adjusting multimedia data flow based on online playing 300 according to the present disclosure. The apparatus for automatically adjusting multimedia data flow based on online playing 300 includes: a request acquiring module 301, a broadband determining module 302, a standard determining module 303, a standard adjustment module 304, a data sending module 305, a peak determining module 306, a right determining module 307, a controllable determining module 308, and a data packet determining module 309. The request acquiring module 301 is connected in sequence to the peak determining module 306, the broadband determining module 302, the right determining module 307, the standard determining module 303, the controllable determining module 308, the data packet determining module 309, the standard adjustment module 304, and the data sending module 305. The peak determining module 306 and the controllable determining module 308 are both connected to the standard adjustment module 304, and the broadband determining module 302, the right determining module 307, the standard determining module 303, and the data packet determining module 309 are all connected to the data sending module 305.

In some optional embodiments, the broadband determining module 302 is configured to: determine whether the occupation ratio of the current broadband is higher than the preset first broadband threshold, if a determining result is negative, determine whether determining results of continuous k times are negative, and if yes, not execute the step of determining whether an occupation ratio of a current broadband is higher than a preset first broadband threshold on m online playing data packet acquisition requests that are received hereafter and directly instruct the data sending module 305 to send the multimedia data packet according to the selected playing standard.

Further, the broadband determining module 302 is configured to: determine whether the determining results of continuous k times are negative;

if the determining results of continuous k times are negative, further subtract 1 from the times threshold k until k is equal to 1; and

if a determining result that the occupation ratio of the current broadband is higher than the preset first broadband threshold occurs once, recover the times threshold to the original value k;

and/or

if the determining results of continuous k times are negative, further add 1 to the quantity threshold m until a value of m reaches a predetermined upper quantity threshold; and

if a determining result that the occupation ratio of the current broadband is higher than the preset first broadband threshold occurs once, recover the quantity threshold m to the original value.

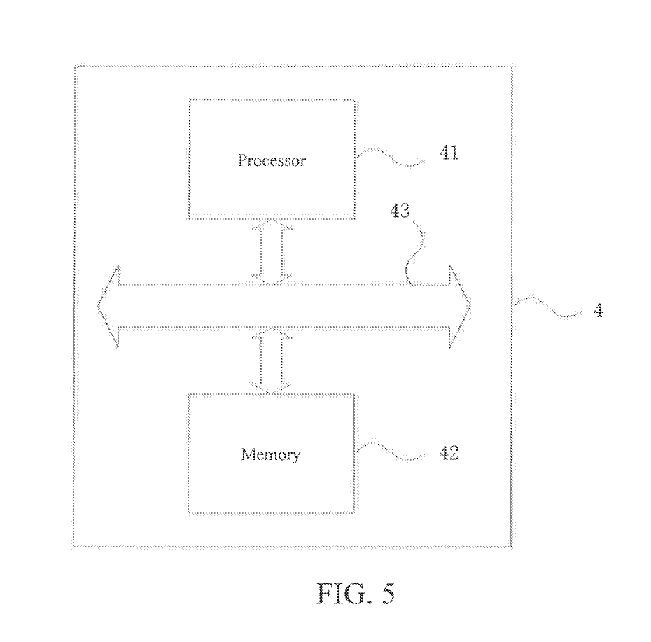

Referring to FIG. 5, FIG. 5 is an embodiment of an electronic device for automatically adjusting multimedia data flow based on online playing 4 provided in the present disclosure. The electronic device for automatically adjusting multimedia data flow based on online playing 4 includes: a processor 41, a memory 42, and a bus system 43. The processor 41 and the memory 42 are connected to each other via the bus system 43. The memory 42 is configured to store program instructions, and the processor 41 is configured to execute the program instructions stored in the memory 42, and the processor 41 is configured to:

receive an online playing data packet acquisition request, which includes a selected playing standard;

determine whether an occupation ratio of a current broadband is higher than a preset first broadband threshold;

if yes, determine whether the selected playing standard is higher than a preset playing standard, and if the selected playing standard is higher than the preset playing standard, adjust a playing standard of a multimedia data packet as the preset playing standard and send the multimedia data packet according to the adjusted playing standard; and if the selected playing standard is not higher than the preset playing standard, send the multimedia data packet according to the selected playing standard; and

if not, send the multimedia data packet according to the selected playing standard.

The memory 42 of the electronic device for automatically adjusting multimedia data flow based on online playing 4 may be a non-transitory computer-readable storage medium, which is configured to store computed executable program instructions. When the program instructions are executed by one or more central processors, for example, the processor 42 may be caused to perform the steps in the above mentioned embodiments of the method, for example, steps 101 to 106 illustrated in FIG. 1, steps 201 to 210 illustrated in FIG. 2. Or, the processor 41 may be caused to perform the modules in the above mentioned embodiments of the electronic device, for example, modules 301 to 305 illustrated in FIG. 3, modules 301 to 309 illustrated in FIG. 4. The computed executable program instructions may also be stored and/or transmitted in any non-transitory computer-readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computer-readable storage medium” may be any tangible medium including or storing computed executable program instructions. The computed executable program instructions may be used by the instruction executing system, apparatus or device, or used in combination with the executing system, apparatus or device. The non-transitory computer-readable storage medium may include, but not limited to, a magnetic, optical and/or semiconductor memory. Examples of these memories include a magnetic disk, an optical disc based on CD, DVD and Blu-ray technology, and permanent solid memory (for example, a flash memory, a solid driver and the like).

It should be understood that in the embodiment of the present application, the processor 41 may be a central processing unit (CPU). The processor 41 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 43 may includes a power bus, a control bus, a state signal bus and the like. However, for clarity of description, various buses are all marked as the bus system 43.

In the embodiment of the present disclosure, the electronic device for automatically adjusting multimedia data flow based on online playing 4 is not limited to the components and configurations as illustrated in FIG. 4, but may includes other or additional components having a plurality of configurations.

During the implementation, various steps in the above method and various modules or units in the above electronic device may be implemented by means of an integrated logic circuit in the processor 41 or by means of software. The steps in the method and modules or the units in the electronic device disclosed in the embodiment of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 42. The processor 41 reads the information stored in the memory 42 and performs the steps of the above method in combination with the hardware thereof. For brevity of description, the details are not given herein any further.

As can be seen from the above, for the method and an apparatus for automatically adjusting multimedia data flow based on online playing provided in the present disclosure include setting a broadband threshold and a corresponding playing standard, quickly recognizing by determining the broadband threshold whether a server is in a high load state, and lowering a relatively high-standard playing standard to a preset playing standard when the server is in the high load state, so as to greatly improve speeds and efficiencies of multimedia data processing and transmission by the server. As a result, an terminal user obtains better experience of online playing of videos. A person skilled in the art should understand that discussion of any foregoing embodiment is only exemplary and is not intended to indicate that a scope (including the claims) of the present disclosure is limited to these examples; under the idea of the present disclosure, the foregoing embodiments of technical features in different embodiments may also be combined, steps may be implemented in any sequence, and many other changes of different aspects of the present disclosure as described above exist and are not provided in detail for concision. Therefore, any omission, modification, equivalent replacement, or improvement made within the spirit and principle of the present disclosure shall fall within the protection scope of the present disclosure.

What is claimed is:

1. A method for automatically adjusting multimedia data flow based on online playing, comprising:
at an electronic device:
receiving an online playing data packet acquisition request, which comprises a selected playing standard;
determining whether an occupation ratio of a current broadband is higher than a preset first broadband threshold;
if yes, determining whether the selected playing standard is higher than a preset playing standard, and if the selected playing standard is higher than the preset playing standard, adjusting a playing standard of a multimedia data packet as the preset playing standard and sending the multimedia data packet according to the adjusted playing standard; and if the selected playing standard is not higher than the preset playing standard, sending the multimedia data packet according to the selected playing standard; and
if not, sending the multimedia data packet according to the selected playing standard.

2. The method according to claim 1, wherein before the step of determining whether an occupation ratio of a current broadband is higher than a preset first broadband threshold, further comprising:
determining whether current time is within an interval of a preset peak period, and if the current time is within the preset peak period, directly adjusting the playing standard of the multimedia data packet as the preset playing standard and sending the multimedia data packet according to the adjusted playing standard; and
if the current time is not within the preset peak period, executing the step of determining whether an occupation ratio of a current broadband is higher than a preset first broadband threshold.

3. The method according to claim 1, wherein before the step of determining whether the selected playing standard is higher than a preset playing standard, further comprising:
acquiring and determining whether an terminal user is an advanced user;
if the terminal user is an advanced user, sending the multimedia data packet according to the selected playing standard; and
if the terminal user is not an advanced user, executing the step of determining whether the selected playing standard is higher than a preset playing standard.

4. The method according to claim 1, wherein before the step of adjusting a playing standard of a multimedia data packet as the preset playing standard, further comprising:
determining whether the occupation ratio of the current broadband is higher than a preset second broadband threshold;
if yes, executing the step of adjusting a playing standard of a multimedia data packet as the preset playing standard, and if not, determining whether an online playing data packet is an opening credit or closing credit part of a multimedia file; and
if the data packet is an opening credit or closing credit part, adjusting the playing standard of the multimedia data packet as the preset playing standard; and if the data packet is not an opening credit or closing credit part, sending the multimedia data packet according to the selected playing standard.

5. The method according to any one of claim 1, wherein if the playing standard has n different levels from low to high, (n−1) first broadband thresholds from low to high are correspondingly set, and if the occupation ratio of the current broadband is greater than an i^{th} first broadband threshold and is not greater than an (i+1)^{th} first broadband threshold, the corresponding preset playing standardise the (n−i)^{th} level, wherein i=1, 2, 3, . . . , n−1, and n is a natural number.

6. The method according to any one of claim 1, wherein after determining whether an occupation ratio of a current broadband is higher than a preset first broadband threshold, further comprising: if a determining result is negative, determining whether determining results of continuous k times are negative, wherein the k is a preset times threshold; and if yes, not executing the step of determining whether an occupation ratio of a current broadband is higher than a preset first broadband threshold on m online playing data packet acquisition requests that are received hereafter and directly sending the multimedia data packet according to the selected playing standard, wherein m is a preset quantity threshold.

7. The method according to claim 6, wherein the step of determining whether determining results of continuous k times are negative further comprises:
if the determining results of continuous k times are negative, further subtracting 1 from the times threshold k until k is equal to 1; and
if a determining result that the occupation ratio of the current broadband is higher than the preset first broadband threshold occurs once, recovering the times threshold to the original value k;
and/or
the determining whether determining results of continuous k times are negative further comprises:
if the determining results of continuous k times are negative, further adding 1 to the quantity threshold m until a value of m reaches a predetermined upper quantity threshold; and
if a determining result that the occupation ratio of the current broadband is higher than the preset first broadband threshold occurs once, recovering the quantity threshold m to the original value.

8. An electronic device, comprising:
at least one processor; and
a memory communicably connected with the at least one processor for storing instructions executable by the at least one processor, wherein execution of the instructions by the at least one processor causes the at least one processor to:
receive an online playing data packet acquisition request, which comprises a selected playing standard;
determine whether an occupation ratio of a current broadband is higher than a preset first broadband threshold;
if yes, determine whether the selected playing standard is higher than a preset playing standard, and if the selected playing standard is higher than the preset playing standard, adjust a playing standard of a multimedia data packet as the preset playing standard and send the multimedia data packet according to the adjusted playing standard; and if the selected playing standard is not higher than the preset playing standard, send the multimedia data packet according to the selected playing standard; and
if not, send the multimedia data packet according to the selected playing standard.

9. The electronic device according to claim 8, wherein before determining whether an occupation ratio of a current broadband is higher than a preset first broadband threshold, the execution of the instructions by the at least one processor further causes the at least one processor to:
determine whether current time is within an interval of a preset peak period, and if the current time is within the preset peak period, directly adjust the playing standard of the multimedia data packet as the preset playing standard and send the multimedia data packet according to the adjusted playing standard; and
if the current time is not within the preset peak period, execute the step of determining whether an occupation ratio of a current broadband is higher than a preset first broadband threshold.

10. The electronic device according to claim 8, wherein before determining whether the selected playing standard is higher than a preset playing standard, the execution of the instructions by the at least one processor further causes the at least one processor to:
acquire and determine whether an terminal user is an advanced user;
if the terminal user is an advanced user, send the multimedia data packet according to the selected playing standard; and
if the terminal user is not an advanced user, execute the step of determining whether the selected playing standard is higher than a preset playing standard.

11. The electronic device according to claim 8, wherein before adjusting a playing standard of a multimedia data packet as the preset playing standard, the execution of the instructions by the at least one processor further causes the at least one processor to:
determine whether the occupation ratio of the current broadband is higher than a preset second broadband threshold;
if yes, execute the step of adjusting a playing standard of a multimedia data packet as the preset playing standard, and if not, determine whether an online playing data packet is an opening credit or closing credit part of a multimedia file; and
if the data packet is an opening credit or closing credit part, adjust the playing standard of the multimedia data packet as the preset playing standard; and if the data packet is not an opening credit or closing credit part, send the multimedia data packet according to the selected playing standard.

12. The electronic device according to claim 8, wherein if the playing standard has n different levels from low to high, (n−1) first broadband thresholds from low to high are correspondingly set, and if the occupation ratio of the current broadband is greater than an ith first broadband threshold and is not greater than an (i+1)^{th} first broadband threshold, the corresponding preset playing standard is the (n−i)^{th} level, wherein i=1, 2, 3, . . . , n−1, and n is a natural number.

13. The electronic device according to claim 8, wherein after determining whether an occupation ratio of a current broadband is higher than a preset first broadband threshold, the execution of the instructions by the at least one processor further causes the at least one processor to:
determine whether an occupation ratio of a current broadband is higher than a preset first broadband threshold; if a determining result is negative, determine whether determining results of continuous k times are negative, wherein the k is a preset times threshold; and if yes, not execute the step of determining whether an occupation ratio of a current broadband is higher than a preset first broadband threshold on m online playing data packet acquisition requests that are received hereafter and directly sending the multimedia data packet according to the selected playing standard, wherein m is a preset quantity threshold.

14. The electronic device according to claim 13, wherein determining whether determining results of continuous k times are negative, the execution of the instructions by the at least one processor further causes the at least one processor to:
if the determining results of continuous k times are negative, further subtract 1 from the times threshold k until k is equal to 1; and
if a determining result that the occupation ratio of the current broadband is higher than the preset first broadband threshold occurs once, recover the times threshold to the original value k;
and/or
the determining whether determining results of continuous k times are negative comprises:
if the determining results of continuous k times are negative, further add 1 to the quantity threshold m until a value of m reaches a predetermined upper quantity threshold; and
if a determining result that the occupation ratio of the current broadband is higher than the preset first broadband threshold occurs once, recover the quantity threshold m to the original value.

15. A non-transitory computer-readable storage medium storing executable instructions, wherein when executed by an electronic device, causes the electronic device to:
receive an online playing data packet acquisition request, which comprises a selected playing standard;
determine whether an occupation ratio of a current broadband is higher than a preset first broadband threshold;
if yes, determine whether the selected playing standard is higher than a preset playing standard, and if the selected playing standard is higher than the preset playing standard, adjust a playing standard of a multimedia data packet as the preset playing standard and send the multimedia data packet according to the adjusted playing standard; and if the selected playing standard is not higher than the preset playing standard, send the multimedia data packet according to the selected playing standard; and
if not, send the multimedia data packet according to the selected playing standard.

16. The non-transitory computer-readable storage medium according to claim 15, wherein before determining whether an occupation ratio of a current broadband is higher than a preset first broadband threshold, when the executable instructions is executed by the electronic device, causes the electronic device to:
determine whether current time is within an interval of a preset peak period, and if the current time is within the preset peak period, directly adjust the playing standard of the multimedia data packet as the preset playing standard and send the multimedia data packet according to the adjusted playing standard; and
if the current time is not within the preset peak period, execute the step of determining whether an occupation ratio of a current broadband is higher than a preset first broadband threshold.

17. The non-transitory computer-readable storage medium according to claim 15, wherein before determining whether the selected playing standard is higher than a preset playing standard, when the executable instructions is executed by the electronic device, further causes the electronic device to:
acquire and determine whether an terminal user is an advanced user;
if the terminal user is an advanced user, send the multimedia data packet according to the selected playing standard; and
if the terminal user is not an advanced user, execute the step of determining whether the selected playing standard is higher than a preset playing standard.

18. The non-transitory computer-readable storage medium according to claim 15, wherein before adjusting a playing standard of a multimedia data packet as the preset playing standard, when the executable instructions is executed by the electronic device, further causes the electronic device to:
determine whether the occupation ratio of the current broadband is higher than a preset second broadband threshold;
if yes, execute the step of adjusting a playing standard of a multimedia data packet as the preset playing standard, and if not, determine whether an online playing data packet is an opening credit or closing credit part of a multimedia file; and
if the data packet is an opening credit or closing credit part, adjust the playing standard of the multimedia data packet as the preset playing standard; and if the data packet is not an opening credit or closing credit part, send the multimedia data packet according to the selected playing standard.

19. The non-transitory computer-readable storage medium according to claim 15, wherein if the playing standard has n different levels from low to high, (n−1) first broadband thresholds from low to high are correspondingly set, and if the occupation ratio of the current broadband is greater than an ith first broadband threshold and is not greater than an (i+1)^{th} first broadband threshold, the corresponding preset playing standard is the (n−i)^{th} level, wherein i=1, 2, 3, . . . , n−1, and n is a natural number.

20. The non-transitory computer-readable storage medium according to claim 19, wherein determining whether determining results of continuous k times are negative, when the executable instructions is executed by the electronic device, further causes the electronic device to:
if the determining results of continuous k times are negative, further subtract 1 from the times threshold k until k is equal to 1; and
if a determining result that the occupation ratio of the current broadband is higher than the preset first broadband threshold occurs once, recover the times threshold to the original value k;
and/or
the determining whether determining results of continuous k times are negative comprises:
if the determining results of continuous k times are negative, further add 1 to the quantity threshold m until a value of m reaches a predetermined upper quantity threshold; and
if a determining result that the occupation ratio of the current broadband is higher than the preset first broadband threshold occurs once, recover the quantity threshold m to the original value.
